(19) United States
(12) Patent Application Publication
(10) Pub. No.: US 2006/0155949 A1
(43) Pub. Date: Jul. 13, 2006

(54) Method and apparatus for allocating memory

(75) Inventor: Jayadeep Purushothaman, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/297,455

(22) Filed: Dec. 9, 2005

(30) Foreign Application Priority Data
Dec. 10, 2004 (GB) 0427049.2

(51) Int. Cl. G06F 12/00

(52) U.S. Cl. 711/170

(57) ABSTRACT

In an embodiment of the present invention there is a method of allocating memory for a computer process, comprising the steps of determining a memory allocation pattern for the computer process, and determining a memory allocation algorithm based on the memory allocation pattern, whereby to facilitate allocation of memory for the computer process.

### FIELD OF THE INVENTION

The present invention relates to a method and apparatus for allocating memory in a computing system.

### BACKGROUND OF THE INVENTION

Many computer processes which are available nowadays require a large amount of computer memory. During operation of a computer process, part, if not all, of the memory required may be satisfied by dynamic memory allocation. General purpose memory allocators, available as part of computing operating systems are used for this allocation.

Because such general purpose allocators allocate memory for a variety of computer processes, memory allocation is not optimum for each process. For any possible allocation algorithm, there is always the possibility that some application programs, for example, will allocate and de-allocate blocks in some fashion that defeats the allocators strategy, and forces it into severe fragmentation. Because the performance of memory allocation algorithms are dependent on operation of a particular computer process for which memory allocation is required, it is not possible to design a general purpose memory allocator that allocates memory in an optimum fashion for all computer processes.

A number of approaches have been proposed to address this problem. These include:

1. To develop general memory allocators that provide reasonable performance for the majority of computer processes. This approach will result in a compromise on performance for most computer processes.

2. Develop custom memory allocators exclusively for each computer process. For example, a custom memory allocator may be developed for each software application. This would be costly in resources and will probably not be practical, certainly not for all applications.

3. To provide different memory allocators for different categories of computer processes eg for multi-tiered applications, applications that allocate large chunks of memory, etc. This is a half way solution between 1 and 2, and is not ideal.

### SUMMARY OF THE INVENTION

In an embodiment of a method of allocating memory for a computer process, the embodiment includes a step of determining a memory allocation pattern for the computer process. In addition to the previous step, the embodiment also includes a step of determining a memory allocation algorithm based on the memory allocation pattern, whereby to facilitate allocation of memory for the computer process.

### BRIEF DESCRIPTION OF THE DRAWINGS

Features and advantages of the present invention, will become apparent from the following description of an embodiment thereof, by way of example only, with reference to the accompanying drawings, in which:

FIG. 1 is a schematic block diagram of an example computing system for implementing an embodiment of the present invention;

FIG. 2 is a flow diagram for illustrating operation of an embodiment of the present invention; and

FIG. 3 is a diagram further illustrating operation of the embodiment of FIGS. 1 and 2.

### DETAILED DESCRIPTION OF EMBODIMENT

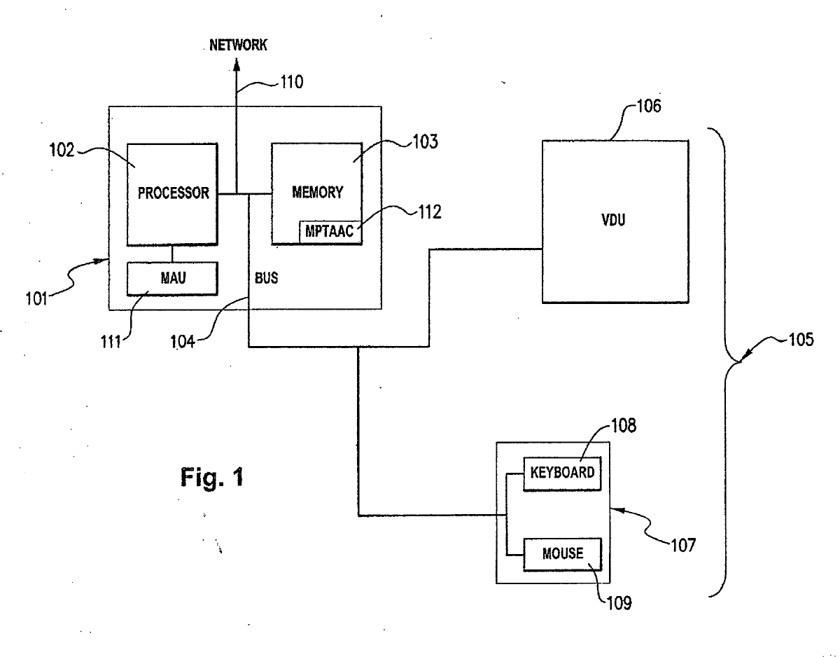

FIG. 1 is a schematic block diagram of an example computing system which may be utilised for implementation of a method and apparatus in accordance with an embodiment of the present invention.

The illustrated computing system includes a computer 101 which includes a processor 102 and memory 103. The processor 102 is arranged to process program instructions and data in a known manner. Memory 103 is arranged to store program instructions and data also in a known manner. Processor 102 may constitute one or more processing means, such as integrated circuit processors. The memory 103 may comprise any known memory architecture and may include hard disk, IC memory (ROM, PROM, RAM, etc), floppy disks and other types of additional memory such as CD ROM, and any other type of memory.

A BUS 104 is provided for communication between the processor 102 and memory 103 and also communication with external components. In this case the external components include a user interface 105. The user interface 105 includes a visual display unit 106 for displaying information to a user. The VDU 106 may display information in graphical format or any other format depending upon the program instructions being processed by processor 102.

The user interface 105 also includes user input means 107 which in this example include a keyboard 108 (which in this example may be a standard QWERTY keyboard) and a mouse 109. The mouse 109 may be used to manipulate a graphical user interface (GUI) if a GUI is provided by software running on the computer. A network connection 110 is also provided for connecting to a network which may include a communication network and other computers/computing systems.

The computing system of FIG. 1 may be implemented by any known type of computing hardware such as, for example, a PC, by a number of networked PCs, by a “mainframe architecture” including a remote computer and user workstations connected to the remote computer, by a client-server architecture, including a client computer accessing a server computer over a network, or by any other computing architecture.

This embodiment of the present invention is implemented by appropriate software providing instructions for operation of the computing system hardware to implement the apparatus of the embodiment and implement the method of the embodiment.

The computing system need not be connected to a network if this is not required by the software or computer architecture.

As part of the operating system of the computer 1, the memory 3 provides a memory allocator, MALLOC 111. The MALLOC 111 is a known software application program interface (API) which is arranged to allocate memory to operation of computer processes such as application programs. MALLOC 111 may be able to select an appropriate memory allocation algorithm from a plurality of available memory allocation algorithms.

In presently available systems the MALLOC 111 will use an appropriate memory allocation algorithm for the system. The memory allocation algorithm used may be pre-set by a provider for an end user of the computing system, for example. The memory allocation algorithm will generally not be varied in dependence on the application program running on the system.

The computer 101 is also loaded with software implementing an embodiment of the present invention. The software is arranged to determine a memory allocation pattern for a computer process running on the computer 101. It is then arranged to determine a memory allocation algorithm based on the memory allocation pattern, whereby the most appropriate memory allocation algorithm for the computer process is selected. The software in this embodiment is in the form of a software utility application which is loaded into memory 103 and is in the form of a memory pattern trace analyser and allocation controller (MPTAAC). The MPTAAC is shown schematically in FIG. 1 by block 112. Note that the MPTAAC 112, although provided as a software application in this embodiment, may alternatively be provided as a hardware component.

Generally, the MPTAAC 112 operates to determine a memory allocation pattern of a computer process or processes operating on the computing system, and, dependent on the determined memory allocation pattern, to select an appropriate memory allocation algorithm for the computer process. In this embodiment the MPTAAC 112 selects one of the available memory allocation algorithms of the MALLOC 111 for memory allocation.

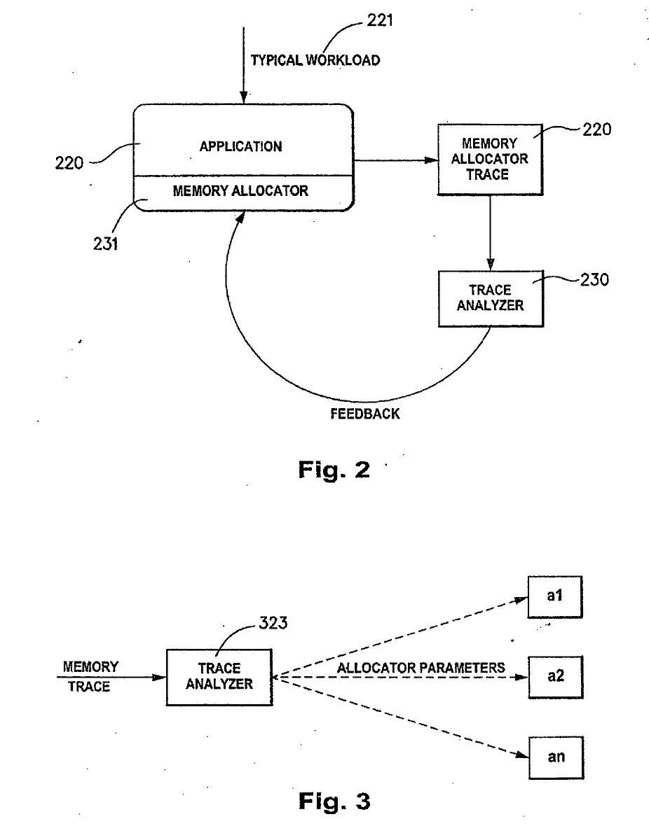

Operation of this embodiment of the invention will now be described in more detail with reference to FIGS. 2 and 3.

In this embodiment, the computer processes being analysed are computer software applications running on the computer 101. In this embodiment, the application(s) memory allocation pattern implicitly drives the selection of the memory allocation algorithm. Profile-based optimisation (PBO) is used to achieve this. The application memory allocation pattern is captured by running a typical work load, and this information is used to feed back to the memory allocator by a selection of an appropriate algorithm for memory allocation.

With reference to FIG. 2, in operation, the application 220 is run with a typical workload 221 to collect the memory allocation pattern of the application. The parameters collected are the following:

1. Size of allocation.

2. Time of allocation/free

3. Thread context of the allocation/free

This “memory allocation trace” is collected by the MPTAAC 112 (step 220). The trace is then analysed (230) by the MPTAAC 12 which decides the allocator policy or parameters, and selects an appropriate memory allocation algorithm available from the MALLOC 111 (231).

The mechanism by which this process is done can be integrated with the compiler as follows:

cc-memory-pbo foo.c

a.out typical-workload-data

cc-memory-pbo-data mpbo.out foo.c

First step is to build the application with memory PBO enabled. Then the application is run with a typical workload which creates the PBO data, mpbo.out, which is used in the next step to create the final application. Compiler will internally invoke the memory trace analyser 112 whose output can be passed to the memory allocator 111 through the program startup code. As shown in FIG. 3, the memory trace analyser 112 process uses (step 23) the input to select an appropriate memory allocator algorithm from an already existing list of allocator algorithms (a1, a2, an).

There can be different ways by which the implementation can be done. For example, as an alternative to the above implementation, one could invoke the analyser manually and collect the inputs and modify the application code itself by setting the right allocator variables using an API. Likewise, different implementation technologies can be used for the various stages of the algorithm. The best implementation methodology should be determined empirically.

In this embodiment, because memory allocation patterns are specific to the computer process or computer processes that are operating, determination of the memory allocation pattern provides a feedback mechanism so that the most suitable memory allocation algorithm can be used for the particular memory allocation pattern. In other words, this approach allows a computer process some input into operation of memory allocation. The allocator adapts to the needs of the computer process based on the type of allocation pattern. This is unlike the prior art, where memory allocation is pre-set regardless of the computer process which is operating. Advantageously, this embodiment of the present invention will lead to more appropriate memory allocation for computer processes.

In the above embodiment, the computer process which is being analysed for memory allocation is a software application. The present invention is not limited to use with software applications. It could be used to allocate memory for any computer process or processes. Nor is the present invention limited to allocating memory separately for each individual computer process. For example, where a number of different computer processes operate on a computer, the overall memory allocation pattern for operation of all the computer processes may be established and an appropriate memory allocation algorithm selected for overall operation of all the processes.

In the above embodiment, the MPTAAC 12 may include data in the form of a “look up” table, matching typical memory allocation patterns with the available memory allocation algorithms. In operation, the memory allocation pattern of the computer process is determined and then matched with the available pattern parameters in the look up table to select the closest match and memory allocator algorithm. The look up table may be pre-determined from experiments with “typical” computer processes.

Modifications and variations as would be apparent to a skilled addressee are deemed to be within the scope of the present invention.

What is claimed is:

1. A method of allocating memory for a computer process, comprising the steps of determining a memory allocation pattern for the computer process, and determining a memory allocation algorithm based on the memory allocation pattern, whereby to facilitate allocation of memory for the computer process.

2. A method in accordance with claim 1, wherein the step of determining a memory allocation pattern includes the step of running a typical workload for the computer process.

3. A method in accordance with claim 1, wherein the step of determining a memory allocation pattern includes the step of determining a size of memory allocation for the computer process.

4. A method in accordance with claim 1, wherein the step of determining the memory allocation pattern includes determining a time of allocation/free parameter for the computer process.

5. A method in accordance with claim 1, wherein the step of determining a memory allocation pattern includes the step of determining a thread context of the allocation/free parameter for the computer process.

6. A method in accordance with claim 1, wherein the step of determining memory allocation algorithm includes the step of analysing the memory allocation pattern using a technique of profile-based optimisation.

7. A method in accordance with claim 1, wherein the step of determining a memory allocation algorithm includes the step of selecting one from a plurality of available memory allocation algorithms.

8. An apparatus for allocating memory for a computer process, the apparatus comprising a memory allocation pattern determination means arranged to determine a memory allocation pattern for the computer process, and a memory allocation determination means, responsive to the determined memory allocation pattern to determine a memory allocation algorithm for the computer process.

9. An apparatus in accordance with claim 8, wherein the memory allocation pattern determination means is arranged to determine a memory allocation pattern from the running of a typical workload for the computer process.

10. An apparatus in accordance with claim 8, wherein the memory allocation pattern determination means is arranged to determine a size of memory allocation for the computer process.

11. An apparatus in accordance with claim 8, wherein the memory allocation pattern determination means is arranged to determine a time of allocation/free parameter for the computer process.

12. An apparatus in accordance with claim 8, wherein the memory allocation pattern determination means is arranged to determine a thread context of the allocation/free parameter for the computer process.

13. An apparatus in accordance with claim 8, wherein the memory allocation determination means is arranged to analyse the memory allocation pattern using a technique of profile-based optimisation.

14. An apparatus in accordance with claim 8, wherein the memory allocation determination means is arranged to select one from a plurality of available memory allocation algorithms.

15. A computer readable medium providing a computer program including instructions for controlling a computing system to implement a method in accordance with claim 1.
